(19) United States
(12) Patent Application Publication
(10) Pub. No.: US 2024/0183466 A1
(43) Pub. Date: Jun. 6, 2024

(54) LARGE-DIAMETER SPIRAL WELDED STEEL PIPE WITH COMPOSITE STRUCTURE WALL AND METHOD FOR MANUFACTURING SAME

(71) Applicant: NANJING DADE STEEL PIPE CO., LTD., Nanjing (CN)

(72) Inventor: Fujun ZHAN, Nanjing (CN)

(73) Assignee: NANJING DADE STEEL PIPE CO., LTD., Nanjing (CN)

(21) Appl. No.: 18/407,547

(22) Filed: Jan. 9, 2024

Related U.S. Application Data
(63) Continuation of application No. PCT/CN2023/110713, filed on Aug. 2, 2023.

(30) Foreign Application Priority Data
Aug. 25, 2022 (CN) 202211023603.4
Aug. 25, 2022 (CN) 202222252797.7

(51) Int. Cl. F16L 9/16; B21C 37/12

(52) U.S. Cl. CPC F16L 9/165; B21C 37/122

(57) ABSTRACT

It discloses a large-diameter spiral welded steel pipe with a composite structure wall, being formed by spirally roll-welding of a double-layer composite steel belt, where the double-layer composite steel belt comprises a first steel belt layer and a second steel belt layer that are disposed in parallel in a staggered manner with equal widths; at least two reinforcing ribs perpendicular to the first steel belt layer and the second steel belt layer are disposed there between and are arranged in a manner of extending together with the steel belt layers; and the reinforcing ribs are disposed on edges respectively between which the first steel belt layer and the second steel belt layer coincide in a vertical direction, and after spirally rolling, adjacent steel belt layers of the steel pipe are connected through staggered edges; and he present invention further discloses a method for manufacturing same.

### CROSS-REFERENCE TO RELATED APPLICATIONS

This application is the U.S. continuation application of International Application No. PCT/CN2023/110713 filed on 2 Aug. 2023 which designated the U.S. and claims priority to Chinese Application Nos. CN202211023603.4 and CN202222252797.7 filed on 25 Aug. 2022, the entire contents of each of which are hereby incorporated by reference.

### TECHNICAL FIELD

The present invention relates to the technical field of welding of steel pipes, and in particular, to a large-diameter spiral welded steel pipe with a composite structure wall and a method for manufacturing same.

### BACKGROUND

Current large-diameter steel pipes are mostly used as water supply pipes, and most of them are buried underground. Therefore, the steel pipe needs to be capable of bearing internal pressure from a medium circulating inside the pipe and further bearing the pressure of an external load, and to prevent a duck-egg shaped deformation caused by its own weight, and thus the wall thickness of the steel pipe needs to be large. In fact, the main purpose of the steel pipe is to convey fluid during which it should be capable of bearing the internal pressure, and to meet this requirement, the wall thickness of the steel pipe does not need to be too large. For example, for a water supply pipe with the diameter being 3 m, to meet the requirement of internal pressure, the wall thickness=PD/zk(σS)=(0.6 MPa*3000 mm)/(2*0.85*177.5 MPa)=5.96 mm. In the above formula, P is an internal pressure, D is an inner diameter of the pipe, σS is an allowable stress, and k is a welding seam coefficient (a spiral welded pipe). The allowable stress is two times of a safety coefficient in the above calculation. It can be seen from the above calculation that when the diameter is 3000 mm and the internal pressure is 0.6 MPa, the wall thickness of the steel pipe only needs to be 5.96 mm. However, in actual applications, in order to prevent the steel pipe from deforming caused by self-weight and by the external pressure when being buried, the wall thickness often needs to be increased. In actual engineering, for the water supply pipe with the diameter being 3 m and the internal pressure being 0.6 MPa, the wall thickness is 25 mm or more, causing a serious waste of materials. In fact, to prevent the steel pipe from deforming caused by self-weight and by the external pressure when being buried, a method of increasing sectional inertia moment of the pipe wall can be used. Although the method of increasing the wall thickness also belongs to the method of increasing the sectional inertia moment of the pipe wall, it only achieves an increase in a proportional multiple relationship rather than a geometric multiple relationship. In addition, when the wall thickness of a steel pipe with a super-large diameter is greater than 25 mm, the steel plate material from a steel factory cannot be delivered in a state of a steel roll, but only in a state of a single flat steel plate. Therefore, the machining manner of the steel pipe is to roll a single steel plate firstly and weld a straight butt seam to make a single-section steel pipe, and the length of the single-section steel pipe is generally 3 m. Then a plurality of single-section steel pipes are butt-welded to make a pipe section of a standard length. This method has low production efficiency; and the force bearing effect of the straight welding seam is worse than that of a spiral welding seam, the welding seam coefficient is low, and thus the required thickness of the steel plate is larger than that of a spiral welded pipe of the same specification, causing a waste of materials.

The applicant has previously applied for a patent with the title of double-wall spiral welded pipe and method for manufacturing same, and the application number of 202110902131.9, which was put into trial production at the beginning of this year. In the trial production process, it was found that welding seams of the inner and outer pipe walls of the steel pipe coincided on a straight line, which is prone to form stress concentration. In addition, in the rolling test process, two vertical reinforcing rings are arranged at the spiral welding seam side by side, as shown in FIG. 1, and thus the strength is too high, which causes difficulties in the rolling process and increases the material cost.

During the trial production and research, the applicant found that for a spiral steel pipe with a double-walled composite structure, the sectional inertia moment of a pipe wall is very large during a rolling process, therefore rolling force needs to be large. The rolling force is formed completely by a forward propulsion force of the steel belt, and driving roller shafts acting on upper and lower parts of the steel belt press the steel belt downwards and upwards to form this propulsion force. In the case of pushing the steel belt through a friction force formed by the roller shafts pressing the steel belt downwards and upwards, when the propulsion force needs to be very large, pressure of the upper and lower roller shafts clamping the steel belt accordingly needs to be very large. Through calculation and actual test, it is shown that when pressing force on the steel belt is very large, a vertical reinforcing rib in the steel belt will be unstable and bent, and the composite steel belt will be flattened, as shown in FIG. 2. If a thickness of the vertical reinforcing rib is increased to solve this problem, the rolling force will be increased, the propulsion force of the steel belt will be increased, the pressing force on the steel belt will be increased, and the vertical reinforcing rib will bear greater pressure, or be crushed, which makes the production and machining impossible.

### SUMMARY

Objectives of the present invention: to overcome deficiencies described in the background, a first objective of the present invention is to disclose a large-diameter spiral welded steel pipe with a composite structure wall; and a second objective is to disclose a method for manufacturing the above mentioned large-diameter spiral welded steel pipe with the composite structure wall.

Technical solutions: the present invention discloses a large-diameter spiral welded steel pipe with a composite structure wall, being formed by spirally roll-welding of a double-layer composite steel belt, where the double-layer composite steel belt comprises a first steel belt layer and a second steel belt layer that are disposed in parallel in a staggered manner with equal widths; at least two reinforcing ribs perpendicular to the first steel belt layer and the second steel belt layer are disposed there between and are arranged in a manner of extending together with the steel belt layers; and the reinforcing ribs are disposed on edges respectively between which the first steel belt layer and the second steel belt layer coincide in a vertical direction, and after spirally rolling, adjacent steel belt layers of the steel pipe are connected through staggered edges.

Further, outer side edges of the reinforcing ribs disposed on the edges respectively between which the first steel belt layer and the second steel belt layer coincide in the vertical direction protrude out of the steel belt layers, and during roll-welding of the double-layer composite steel belt, a protruding portion of the reinforcing rib on one side is overlapped with the staggered edge of the steel belt on the other side that reaches a joint position of the steel belt after rolling by one circle to form a welding groove with the steel belt layer.

Through the welding grooves, the contacted reinforcing ribs and the adjacent steel belt layers can be welded together, and the pipe wall can be smooth after welding.

Further, a plurality of reinforcing ribs are also disposed at intervals between the reinforcing ribs on both sides of the steel belt layers to support the inside of the first steel belt layer and the second steel belt layer, and all the reinforcing ribs are arranged in a manner of being parallel to each other and extending together.

Further, the reinforcing ribs additionally disposed inside the steel belt layers are integrally welded to the steel belt layers by means of penetrating welding.

Further, in a case where the penetrating welding is not used, the first steel belt layer is formed by welding of a plurality of split steel belts arranged side by side, each joint seam of adjacent split steel belts corresponds to one reinforcing rib, and during roll-welding of the double-layer composite steel belt, the first steel belt layer is located on an outer wall of the pipe.

During welding of the joint seam of the adjacent split steel belts, the adjacent split steel belts can be welded to the corresponding reinforcing rib at the same time, thereby achieving fixation of the three, so that the structure is more stable.

In addition, since welding seams exist between the split steel belts, and continuous spiral welding seams are formed when the pipe is formed by roll-welding, and the spiral welding seams do not facilitate rapid passing of water flow, therefore, during roll-welding of the double-layer composite steel belt, the first steel belt layer is located on the outer wall of the pipe, so that the spiral welding seams are located on the outer wall of the pipe. Further, cavities between the first steel belt layer and the second steel belt layer are filled with concrete.

Further, shear nails are disposed on an inner side of each of the first steel belt layer and the second steel belt layer.

Further, reinforcing steel bars are disposed between the first steel belt layer and the second steel belt layer.

Further, the reinforcing rib is a shaped steel, such as an H-shaped steel, a channel steel, an angle steel bar, a thin steel pipe, a reinforcing steel bar, or a corrugated steel.

A method for manufacturing the above mentioned large-diameter spiral welded steel pipe with the composite structure wall comprises the following steps:
S1: obtaining a second steel belt by unwinding of a steel roll to be horizontally placed so as to form a second steel belt layer;
S2: obtaining reinforcing ribs by unwinding of a plurality of vertical steel rolls to be placed perpendicular to the second steel belt layer, where one of the two outermost reinforcing ribs is placed at an end portion of a side edge of the second steel belt layer, and the other reinforcing rib is placed at a distance from an end portion of the other side of the second steel belt layer, and a bottom of the reinforcing rib is welded to the second steel belt layer;
S3: obtaining a first steel belt with a width the same as that of the second steel belt by unwinding of a steel roll to be horizontally placed on the reinforcing ribs corresponding to the second steel belt in a staggered manner to form a first steel belt layer, where the two reinforcing ribs mentioned in S2 correspond to a position at a distance from an end portion of one side of the first steel belt layer and a position of an end portion of the other side edge of the first steel belt layer respectively, and are welded to be fixed so as to form a double-layer composite steel belt; and
S4: performing spiral bending rolling on the double-layer composite steel belt by using a spiral steel welded pipe machining device, and continuously welding welding seams on the inside and outside of the pipe for continuous shaping of the steel pipe.

In S3, outer side edges of the reinforcing ribs disposed on the edges between which the first steel belt layer and the second steel belt layer coincide in the vertical direction protrude out of the steel belt layers, and in S4, during rolling, when the steel belt is rolled by one circle of path and comes into contact with the edge of an unrolled steel belt, a protruding portion of the reinforcing rib on one side overlaps a staggered edge on the other side to form a welding groove with the steel belt layer, and welding grooves on the inside and outside of the pipe are welded to be fixed.

Further, in S3, the remaining reinforcing ribs except the reinforcing ribs on both sides are integrally welded to the second steel belt layer by means of penetrating welding.

Further, in S3, the first steel belt layer comprises a plurality of split steel belts arranged side by side, each of the split steel belts is obtained by unwinding of a steel roll and placed on the reinforcing ribs, and each joint seam of adjacent split steel belts corresponds to one reinforcing rib to form a welding seam, and the three are welded to be fixed through the welding seam.

Further, in S4, after being manufactured, the double-layer composite steel belt enters between an upper pressing roller and a lower pressing roller of a delivery propulsion device which press outer sides of the first steel belt layer and the second steel belt layer respectively, the upper pressing roller and the lower pressing roller each are provided with a pressure enhancing wheel at a position corresponding to a welding edge of each of the first steel belt layer and the second steel belt layer, the pressure enhancing wheels and the pressing rollers press the inner and outer surfaces of the welding edges respectively to increase a contact area between the propulsion device and the double-layer composite steel belt, thereby improving a propulsion force, and ensuring that a section of the steel belt is not deformed under the pressure and the propulsion force.

Further, concrete is filled between the first steel belt layer and the second steel belt layer.

Beneficial effects: compared with the prior art, advantages of the present invention are as follows.
1. Welding seams of the inner pipe wall and the outer pipe wall of the spiral welded steel pipe designed in the present invention do not coincide, thereby avoiding stress concentration and improving the strength of the steel pipe.
2. In the manufacturing process of the spiral welded steel pipe designed in the present invention, the steel belt layers are arranged in a staggered manner, and only one reinforcing rib is needed at the welding groove to complete butt joint of staggered edges during rolling, so that steel material consumption is reduced.
3. For the spiral welded steel pipe of the present invention, in the process of pushing, by means of a design of staggered edges of single-layer steel plates on the left and right sides of a composite steel belt structure and the addition of the pressure enhancing wheels in a pushing structure corresponding thereto, the pressure of the pressure enhancing wheels is applied to the single-layer steel plate with the staggered edge, therefore, there is no need to worry about the composite steel belt being deformed under pressure, so that the propulsion force is improved, and it is ensured that a section of the steel belt is not deformed under the pressure and the propulsion force.
4. When the plurality of reinforcing ribs are additionally disposed in the double-layer composite steel belt of the present invention, the reinforcing ribs and the steel belt layers can be directly fixed by using the penetrating welding technology, so that both of the steel belt layers can use a whole steel belt without splitting.
5. For double-layer composite steel belts with the same width, compared with a composite steel belt with a rectangular section of the patent previously applied, the structure of the present patent application has greatly reduced sectional inertia moment, thereby greatly reducing the power of a production device, in addition, reducing the strength requirements on the structure of the device, and reducing the cost of the device.
6. After concrete is filled between the two layers of the steel belts, the first layer of steel belt and the second layer of steel belt can transfer force mutually, and cooperate with the concrete to bear an internal pressure and an external pressure, so as to form a combined steel and concrete structure. The concrete has supporting and restraining effects on surrounding steel plates, preventing the steel plates from being forced to buckle. In addition, the surrounding steel plates have wrapping and restraining effects on the concrete, so that compression resistance of the concrete is improved.

### BRIEF DESCRIPTION OF DRAWINGS

FIG. 1 is a structural diagram of a welding groove of the prior application 202110902131.9;

FIG. 2 is a structural diagram of a composite steel belt of the prior application 202110902131.9 after being excessively compressed to be deformed;

FIG. 3 is a structural diagram of a large-diameter spiral welded steel pipe with a composite structure wall according to the present invention;

FIG. 4 is a section view of a double-layer composite steel belt in an extending direction according to the present invention;

FIG. 5 is a section view of reinforcing ribs inside a double-layer composite steel belt according to the present invention;

FIG. 6 is a structural diagram of split steel belts of a double-layer composite steel belt according to the present invention;

FIG. 7 is a flowchart of manufacturing by using penetrating welding according to the present invention;

FIG. 8 is a flowchart of manufacturing by using split steel belts according to the present invention;

FIG. 9 is a structural diagram of pressure enhancing wheels according to the present invention;

FIG. 10 is a cross sectional view of a steel pipe after cutting according to the present invention; and

FIG. 11 is an enlarged structural diagram of welding grooves at A in FIG. 10 according to the present invention.

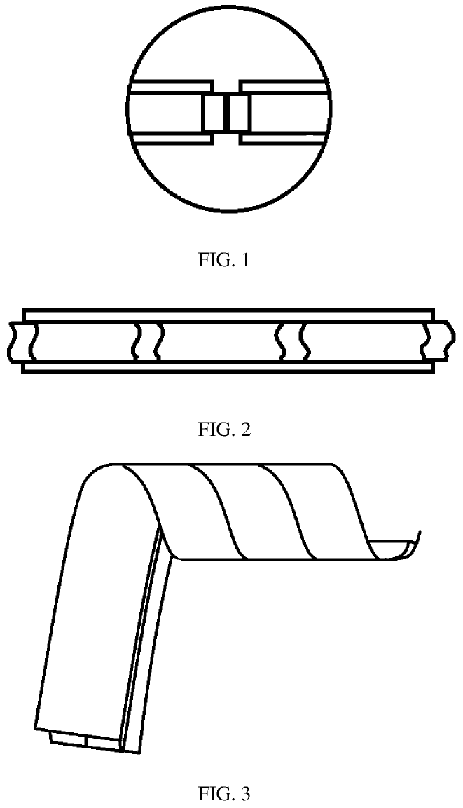

### DETAILED DESCRIPTION OF THE EMBODIMENTS

The present invention is further described in detail below in conjunction with accompanying drawings and specific embodiments.

A large-diameter spiral welded steel pipe with a composite structure wall as shown in FIG. 3 is formed by spirally roll-welding of a double-layer composite steel belt.

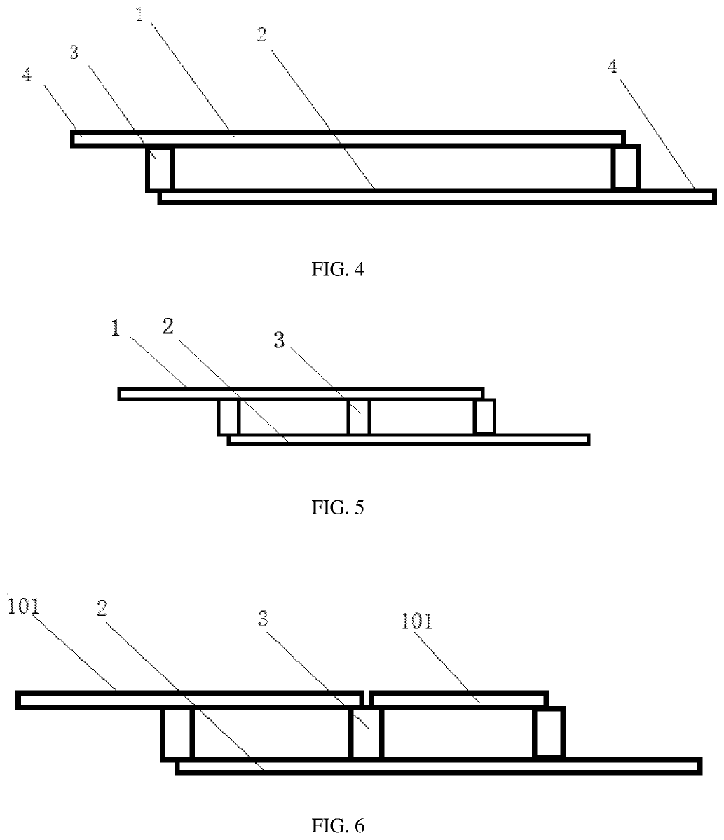

As shown in FIG. 4, the double-layer composite steel belt comprises a first steel belt layer 1 and a second steel belt layer 2 that are disposed in parallel in a staggered manner with equal widths, two reinforcing ribs 3 perpendicular to the first steel belt layer 1 and the second steel belt layer 2 are disposed therebetween, the reinforcing ribs 3 are disposed on edges respectively between which the first steel belt layer 1 and the second steel belt layer 2 coincide in a vertical direction, and are arranged in a manner of extending together with the steel belt layers; the first steel belt layer 1, the second steel belt layer 2 and the reinforcing ribs 3 at end portions of both side edges are mutually welded to form a double-layer composite steel belt, the adjacent steel belt layers of the steel pipe are connected through staggered edges 4, and concrete is filled between the double-layer steel belt.

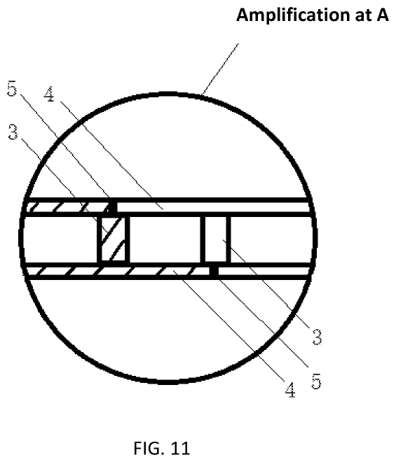

As shown in FIG. 11, outer side edges of the reinforcing ribs 3 disposed on the edges respectively between which the first steel belt layer 1 and the second steel belt layer 2 coincide in the vertical direction protrude out of the steel belt layers, and during roll-welding of the double-layer composite steel belt, a protruding portion of the reinforcing rib on one side is overlapped with the staggered edge 4 of the steel belt on the other side that reaches a joint position of the steel belt after rolling by one circle to form a welding groove 5 with the steel belt layer, and the steel belt can be formed by roll-welding through the welding groove 5.

As shown in FIG. 5, a reinforcing rib 3 is further disposed between the reinforcing ribs 3 on the both sides of the steel belt layers to support the inside of the first steel belt layer 1 and the second steel belt layer 2, and all the reinforcing ribs 3 are arranged in a manner of being parallel to each other and extending together. Considering that the reinforcing rib 3 additionally disposed inside the steel belt layers is inconvenient to be fixed with the first steel belt layer 1, in this embodiment, the reinforcing rib and the steel belt layer are integrally welded by means of penetrating welding.

As shown in FIG. 6, if the penetrating welding process is not used, considering that the internal reinforcing rib 3 is inconvenient to be welded to the steel belt layer, the first steel belt layer 1 needs to be divided into a plurality of split steel belts 101 which are arranged side by side and welded, and each joint seam of adjacent split steel belts 101 corresponds to one reinforcing rib 3. To avoid a negative effect of these continuous welding seams on drainage, during roll-welding of the above mentioned double-layer composite steel belt, the first steel belt layer 1 is located on an outer wall of the pipe, so that the welding seams are generated on the outer wall of the pipe.

Shear nails are disposed on an inner side of each of the first steel belt layer 1 and the second steel belt layer 2, reinforcing steel bars are disposed, and concrete is filled in cavities. The reinforcing rib 3 is a shaped steel, such as an H-shaped steel, a channel steel, an angle steel bar, a thin steel pipe, a reinforcing steel bar, or a corrugated steel, etc.

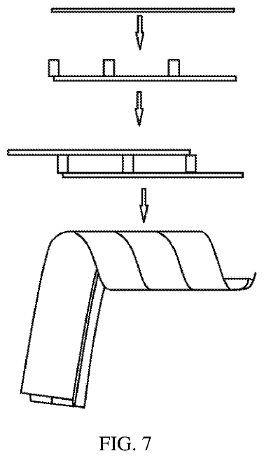

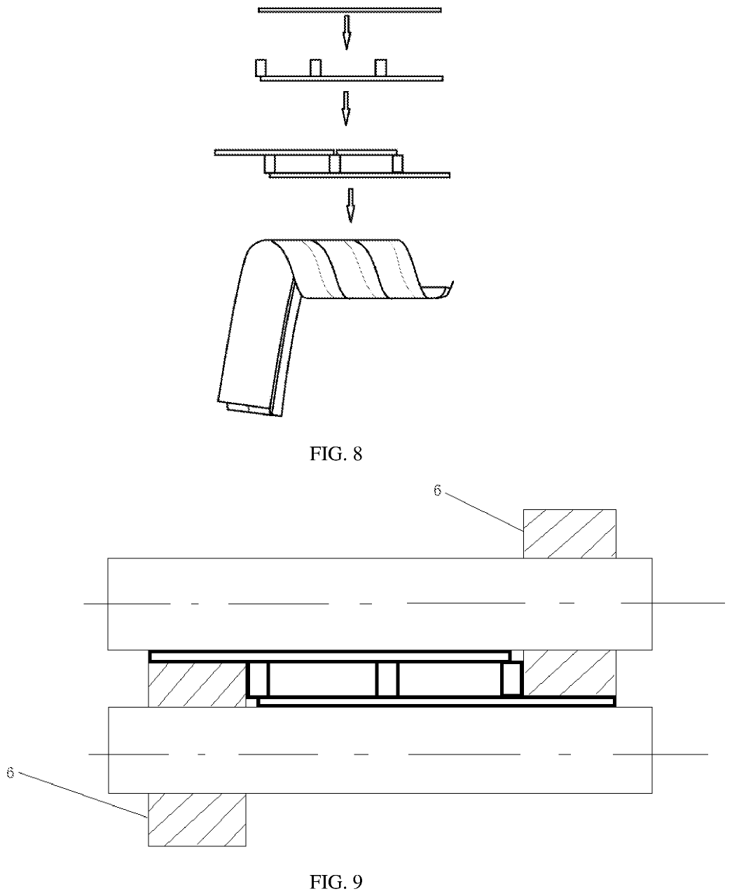

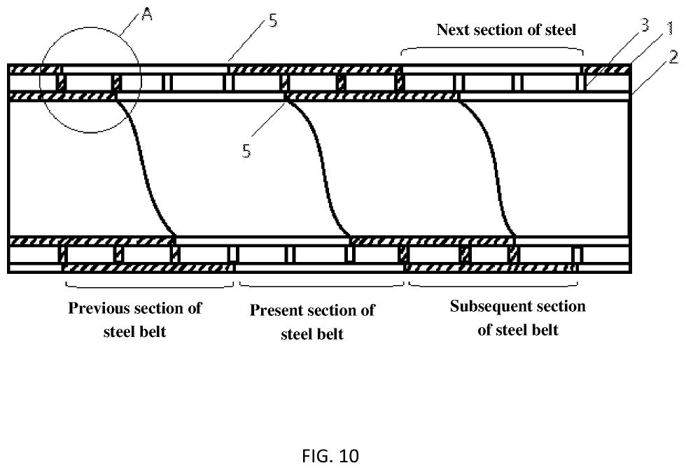

As shown in FIG. 7, a method for manufacturing the above mentioned large-diameter spiral welded steel pipe with a composite structure wall comprises the following steps.
S1: A second steel belt is obtained by unwinding of a steel roll and horizontally placed to form a second steel belt layer 2.
S2: Reinforcing ribs 3 are obtained by unwinding of a plurality of vertical steel rolls and placed perpendicular to the second steel belt layer 2, where one of the two outermost reinforcing ribs 3 is placed at an end portion of a side edge of the second steel belt layer 2, and the other reinforcing rib 3 is placed at a distance from an end portion of the other side of the second steel belt layer 2, a reinforcing rib is additionally disposed between the reinforcing ribs 3 on both sides, reinforcing ribs are arranged in a manner of extending together, and a bottom of the reinforcing rib 3 is welded to the second steel belt layer 2.
S3: A first steel belt with a width the same as that of the second steel belt is obtained by unwinding of a steel roll and horizontally placed on the reinforcing ribs 3 corresponding to the second steel belt in a staggered manner to form a first steel belt layer 1, where the two reinforcing ribs 3 mentioned in S2 correspond to a position at a distance from an end portion of one side of the first steel belt layer 1 and a position of an end portion of the other side edge of the first steel belt layer 1 respectively, and are welded to be fixed so as to form a double-layer composite steel belt. The remaining reinforcing ribs 3 except the reinforcing ribs 3 on both sides are integrally welded to the second steel belt layer 2 by means of penetrating welding, where outer side edges of the reinforcing ribs 3 disposed on edges between which the first steel belt layer 1 and the second steel belt layer 2 coincide in a vertical direction protrude out of the steel belt layers. If the penetrating welding process is not used in this step, considering that the internal reinforcing rib 3 is inconvenient to be welded to the steel belt layers, the first steel belt layer 1 is divided into two split steel belts 101 which are arranged side by side, each of the split steel belts are obtained by unwinding of a steel roll and placed on the reinforcing ribs 3, and each joint seam of adjacent split steel belts 101 corresponds to one reinforcing rib 3 to form a welding seam, the three are welded to be fixed through the welding seam, and the process is as shown in FIG. 8.
S4: After being manufactured, the double-layer composite steel belt enters between an upper pressing roller and a lower pressing roller of a delivery propulsion device which press outer sides of the first steel belt layer 1 and the second steel belt layer 2 respectively, as shown in FIG. 9, the upper pressing roller and the lower pressing roller each are provided with a pressure enhancing wheel 6 at a position corresponding to a staggered edge 4 of each of the first steel belt layer 1 and the second steel belt layer 2, the pressure enhancing wheels 6 and the pressing rollers press the inner and outer surfaces of the staggered edges 4 respectively, then spiral bending rolling is performed by using a machining device, and welding seams on the inside and outside of the pipe are continuously welded for continuous shaping of the steel pipe. During rolling, when the steel belt is rolled by one circle of path and comes into contact with the edge of an unrolled steel belt, a protruding portion of the reinforcing rib on one side overlaps a welding edge on the other side to form a welding groove 5 with the steel belt layer, and welding grooves 5 on the inside and outside of the pipe are welded to be fixed, as shown in FIG. 10 and FIG. 11.

What is claimed is:

1. A large-diameter spiral welded steel pipe with a composite structure wall, being formed by spirally roll-welding of a double-layer composite steel belt, wherein the double-layer composite steel belt comprises a first steel belt layer (1) and a second steel belt layer (2) that are disposed in parallel in a staggered manner with equal widths; at least two reinforcing ribs (3) perpendicular to the first steel belt layer (1) and the second steel belt layer (2) are disposed there between and are arranged in a manner of extending together with the steel belt layers; and the reinforcing ribs (3) are disposed on edges respectively between which the first steel belt layer (1) and the second steel belt layer (2) coincide in a vertical direction, and after spirally rolling, adjacent steel belt layers of the steel pipe are connected through staggered edges.

2. The large-diameter spiral welded steel pipe with the composite structure wall according to claim 1, wherein outer side edges of the reinforcing ribs (3) disposed on the edges between which the first steel belt layer (1) and the second steel belt layer (2) coincide in the vertical direction protrude out of the steel belt layers, and during roll-welding of the double-layer composite steel belt, a protruding portion of the reinforcing rib on one side is overlapped with a staggered edge (4) of the steel belt on the other side that reaches a joint position of the steel belt after rolling by one circle to form a welding groove (5) with the steel belt layer.

3. The large-diameter spiral welded steel pipe with the composite structure wall according to claim 1, wherein a plurality of reinforcing ribs (3) are also disposed at intervals between the reinforcing ribs (3) on both sides of the steel belt layers to support the inside of the first steel belt layer (1) and the second steel belt layer (2), and all the reinforcing ribs (3) are arranged in a manner of being parallel to each other and extending together.

4. The large-diameter spiral welded steel pipe with the composite structure wall according to claim 3, wherein the reinforcing ribs (3) additionally disposed inside the steel belt layers are integrally welded to the steel belt layers by means of penetrating welding.

5. The large-diameter spiral welded steel pipe with the composite structure wall according to claim 3, wherein the first steel belt layer (1) is formed by welding of a plurality of split steel belts (101) arranged side by side, each joint seam of adjacent split steel belts (101) corresponds to one reinforcing rib (3), and during roll-welding of the double-layer composite steel belt, the first steel belt layer (1) is located on an outer wall of the pipe.

6. The large-diameter spiral welded steel pipe with the composite structure wall according to claim 1, wherein cavities between the first steel belt layer (1) and the second steel belt layer (2) are filled with concrete.

7. The large-diameter spiral welded steel pipe with the composite structure wall according to claim 1, wherein shear nails are disposed on an inner side of each of the first steel belt layer (1) and the second steel belt layer (2).

8. The large-diameter spiral welded steel pipe with the composite structure wall according to claim 1, wherein reinforcing steel bars are disposed between the first steel belt layer (1) and the second steel belt layer (2).

9. The large-diameter spiral welded steel pipe with the composite structure wall according to claim 1, wherein the reinforcing rib (3) is a shaped steel, such as an H-shaped steel, a channel steel, an angle steel bar, a thin steel pipe, a reinforcing steel bar, or a corrugated steel.

10. A method for manufacturing the large-diameter spiral welded steel pipe with the composite structure wall according to claim 1, comprising the following steps:
S1: obtaining a second steel belt by unwinding of a steel roll to be horizontally placed so as to form a second steel belt layer 2;
S2: obtaining reinforcing ribs (3) by unwinding of a plurality of vertical steel rolls to be placed perpendicular to the second steel belt layer (2), wherein one of the two outermost reinforcing ribs (3) is placed at an end portion of a side edge of the second steel belt layer (2), and the other reinforcing rib (3) is placed at a distance from an end portion of the other side of the second steel belt layer (2), and a bottom of the reinforcing rib (3) is welded to the second steel belt layer (2);
S3: obtaining a first steel belt with a width the same as that of the second steel belt by unwinding of a steel roll to be horizontally placed on the reinforcing ribs (3) corresponding to the second steel belt in a staggered manner to form a first steel belt layer (1), wherein the two reinforcing ribs (3) mentioned in S2 correspond to a position at a distance from an end portion of one side of the first steel belt layer (1) and a position of an end portion of the other side edge of the first steel belt layer (1) respectively, and are welded to be fixed so as to form a double-layer composite steel belt; and
S4: performing spiral bending rolling on the double-layer composite steel belt by using a spiral steel welded pipe machining device, and continuously welding welding seams on the inside and outside of the pipe for continuous shaping of the steel pipe.

11. The method for manufacturing the large-diameter spiral welded steel pipe with the composite structure wall according to claim 10, wherein in S3, outer side edges of the reinforcing ribs (3) disposed on the edges between which the first steel belt layer (1) and the second steel belt layer (2) coincide in the vertical direction protrude out of the steel belt layers, and in S4, during rolling, when the steel belt is rolled by one circle of path and comes into contact with the edge of an unrolled steel belt, a protruding portion of the reinforcing rib on one side overlaps a staggered edge on the other side to form a welding groove (5) with the steel belt layer, and welding grooves (5) on the inside and outside of the pipe are welded to be fixed.

12. The method for manufacturing the large-diameter spiral welded steel pipe with the composite structure wall according to claim 10, wherein in S3, the remaining reinforcing ribs (3) except the reinforcing ribs (3) on both sides are integrally welded to the second steel belt layer (2) by means of penetrating welding.

13. The method for manufacturing the large-diameter spiral welded steel pipe with the composite structure wall according to claim 10, wherein in S3, the first steel belt layer (1) comprises a plurality of split steel belts (101) arranged side by side, each of the split steel belts is obtained by unwinding of a steel roll and placed on the reinforcing ribs (3), and each joint seam of adjacent split steel belts (101) corresponds to one reinforcing rib (3) to form a welding seam, and the three are welded to be fixed through the welding seam.

14. The method for manufacturing the large-diameter spiral welded steel pipe with the composite structure wall according to claim 10, wherein in S4, after being manufactured, the double-layer composite steel belt enters between an upper pressing roller and a lower pressing roller of a delivery propulsion device which press outer sides of the first steel belt layer (1) and the second steel belt layer (2) respectively, the upper pressing roller and the lower pressing roller each are provided with a pressure enhancing wheel (6) at a position corresponding to a welding edge (4) of each of the first steel belt layer (1) and the second steel belt layer (2), the pressure enhancing wheels (6) and the pressing rollers respectively press the inner and outer surfaces of the welding edges (4).

15. The method for manufacturing the large-diameter spiral welded steel pipe with the composite structure wall according to claim 10, wherein concrete is filled between the first steel belt layer (1) and the second steel belt layer (2).
